(19) United States
(12) Patent Application Publication
(10) Pub. No.: US 2014/0045156 A1
(43) Pub. Date: Feb. 13, 2014

(54) METHODS FOR MANAGING LIFESTYLE OF INDIVIDUALS

(71) Applicants: Nerio Alessandri, Cesena (IT); Alessandro Pasini, Cesena (IT); Silvano Zanuso, Roncofreddo (IT)

(72) Inventors: Nerio Alessandri, Cesena (IT); Alessandro Pasini, Cesena (IT); Silvano Zanuso, Roncofreddo (IT)

(21) Appl. No.: 13/569,101

(22) Filed: Aug. 7, 2012

(51) Int. Cl. G09B 19/00

(52) U.S. Cl. 434/236

(57) ABSTRACT

Disclosed are computer-implemented methods and systems for managing the lifestyle of individuals and generation of suggested actions to be taken by a user to improve wellness depending on current user condition. The methods and systems facilitate acquiring multiple biometric and psychophysical parameters of the user and calculating a single wellness index. The wellness index depends on goals, objectives, results, social feedback, rewards, and so forth. The methods and systems may further generate at least one proposed action, wherein the action is to improve the wellness index.

### TECHNICAL FIELD

This disclosure relates generally to monitoring health, wellness, and fitness conditions, and, more specifically, to computer-implemented methods and systems for managing the lifestyle of individuals by monitoring a wellness index, which is calculated using a combination of biometrical, psychophysical, and nutritional parameters for interactively guiding individuals to increase the wellness index by generating specific proposals.

### DESCRIPTION OF RELATED ART

The approaches described in this section could be pursued but are not necessarily approaches that have been previously conceived or pursued. Therefore, unless otherwise indicated, it should not be assumed that any of the approaches described in this section qualify as prior art merely by virtue of their inclusion in this section.

There is a tremendous need for adults to improve their physical activity and healthy habits. Simply buying an exercise machine or reading a book on proper diet is typically not enough to establish lifelong healthy habits. In general, physical activity and nutrition should be planned and implemented on an individual basis depending on current psychophysical condition and sought goals. To be successful in this process, many factors should be taken into account, not to mention that the individual has to possess specific knowledge in the field of physical activities and nutrition. An abundance of information related to health and wellness improvement makes it confusing and difficult to succeed.

Various monitoring technologies are available to help individuals assess their physical condition. For example, heart rate monitors, blood pressure monitors, digital weighing machines, physical activity sensors (pedometers, accelerometers, running/cycling tracking systems, exercise tracking systems), and so forth may help people learn their current physical parameters. In most cases, these parameters are provided directly to the individual, and to evaluate current physical conditions, it is necessary to compare the obtained parameters with normative values. Even if the user can assess various obtained physical parameters with respect to the normative values, it is a difficult task for the user to combine assessments of all measured parameters and evaluate his or her overall health and wellness condition.

Furthermore, it can be challenging to understand what steps are to be taken to improve health and wellness conditions, or what should be done by an individual to achieve certain goals in weight loss, weight gain, improving sports results, and so forth. This is a difficult task not only for ordinary individuals, but also for nutrition and sport professionals.

### SUMMARY

This summary is provided to introduce a selection of concepts in a simplified form that are further described below in the Detailed Description. This summary is not intended to identify key features or essential features of the claimed subject matter, nor is it intended for use as an aid in determining the scope of the claimed subject matter.

The present disclosure relates to computer-implemented methods and systems for managing the lifestyle of individuals and generation of suggested actions to be taken to improve wellness depending on the current condition of a given individual. In general, these methods and systems enable the individual to acquire and process various and multiple parameters related to his or her physical and mental condition and calculate a single wellness index based thereon. The wellness index can be visually represented in a number of different ways; for example, it may have values of “high,” “medium,” and “low.” The wellness index may depend not only on measured parameters, but also on set goals such as weight loss goals, weight gain goals, and sport results, in addition to set objectives, perceived obstacles, social feedback, rewards, and so forth.

The wellness index may be calculated repeatedly over a long period of time, and, based upon changes in the wellness index and/or the parameters measured, one or more proposed actions on effective ways to increase the wellness index and improve lifestyle can be generated. The proposed actions may relate to an exercise plan, nutrition plan, or any other activity.

Thus, the disclosed methods and systems for wellness monitoring provide a useful and effective way to improve health, wellness, and fitness conditions in an easy, intuitive, and interactive way. The evidence-based and cognitive technology disclosed herein may further help individuals adopt and maintain higher levels of physical activity and improved healthy habits over a long period of time.

In various embodiments, there is provided a computer-implemented method for managing the lifestyle of individuals. An example method may comprise acquiring at least one physiological parameter related to a user, calculating a wellness index based upon the at least one physiological parameter, and generating at least one proposed action to the user so as to improve the wellness index.

In various embodiments, the at least one physiological parameter may comprise one or more of a weight, height, a BMI (Body Mass Index), a waist circumference value, heart rate, blood pressure, blood sugar, cholesterol, stress level, rest level, activity level, calories burned, and sleep quality.

The method may further comprise acquiring at least one physical activity parameter related to the user, and the wellness index can be calculated based further upon the at least one physical activity parameter. The at least one physical activity parameter may comprise one or more of speed, distance, number of steps, acceleration, and cadence, and any other parameter calculated or deriving from acceleration sensor signals and indicative of the amount/intensity of physical activity.

The method may further comprise acquiring at least one foods-consumed parameter related to the user, and the wellness index can be calculated based further upon the at least one foods-consumed parameter. The at least one foods-consumed parameter may comprise one or more of consumed calories, type of foods, and amount of foods-consumed.

The method may further comprise acquiring at least one image of a nutrition product to be consumed by the user, determining nutrition values associated with the nutrition product, and facilitating a calculation of the at least one foods-consumed parameter based upon the nutrition values.

The method may further comprise acquiring at least one bar code of a nutrition product to be consumed by the user, determining nutrition values associated with the nutrition product, and facilitating a calculation of the at least one foods-consumed parameter based upon the nutrition values. The at least one physiological parameter can be acquired repeatedly over at least one period of time.

The method may further comprise comparing the at least one physiological parameter to one or more reference parameter values so as to determine one or more deviations, and the wellness index can be calculated based upon on the one or more deviations.

The method may further comprise determining at least one mediator and generating the at least one proposed action based upon the at least one mediator. The at least one mediator can be determined by processing user inputs (e.g., obtained via a survey or questionnaire) associated with current physical and/or mental condition. Further, the at least one proposed action can comprise one or more of a training program, exercise program, nutrition plan, and physical activity plan. The at least one proposed action may comprise one or more of a target objective, target wellness index, target physiological parameter, target physical activity parameter, and target foods-consumed parameter.

In accordance with another aspect, there is provided a system for managing the lifestyle of individuals. An example system may comprise a communication module configured to acquire at least one physiological parameter related to a user, and a controlling module configured to calculate a wellness index based upon the at least one physiological parameter and generate at least one proposed action to the user so as to improve the wellness index.

In various embodiments, the communication module can be further configured to acquire at least one physical activity parameter related to the user, and the wellness index can be calculated based further upon the at least one physical activity parameter.

The communication module can be further configured to acquire at least one foods-consumed parameter related to the user, and the wellness index can be calculated based further upon the at least one foods-consumed parameter.

The communication module can be further configured to acquire at least one image of a nutrition product to be consumed by the user, and the controlling module can be further configured to determine nutrition values associated with the nutrition product and facilitate calculation of the at least one foods-consumed parameter based upon the nutrition values.

The communication module can be further configured to acquire at least one bar code of a nutrition product to be consumed by the user, and the controlling module can be further configured to determine nutrition values associated with the nutrition product and facilitate calculation of the at least one foods-consumed parameter based upon the nutrition values.

The controlling module can be further configured to compare the at least one physiological parameter to the one or more reference parameter values so as to determine one or more deviations, and the wellness index can be calculated based upon on the one or more deviations.

The controlling module can be further configured to determine at least one mediator and generate at least one proposed action based upon the at least one mediator.

The system may further comprise at least one sensor configured to measure one or more of a physiological parameter and physical activity parameter. The system may further comprise a display. The system may further comprise one or more input devices. The system may comprise one or more of a computer, cellular phone, smartphone, personal digital assistant (PDA), set-top box, smart television system, and physical exercise machine.

In accordance with yet another aspect, there is provided a processor-readable medium having instructions stored thereon. The instructions, when executed by one or more processors, may cause the one or more processors to acquire at least one physiological parameter related to a user, calculate a wellness index based upon the at least one physiological parameter, and generate at least one proposed action to the user so as to improve the wellness index.

To the accomplishment of the foregoing and related ends, the one or more aspects comprise the features hereinafter fully described and particularly pointed out in the claims. The following description and the drawings set forth in detail certain illustrative features of the one or more aspects. These features are indicative of just a few of the various ways in which the principles of various aspects may be employed, and this description is intended to include all such aspects and their equivalents.

### BRIEF DESCRIPTION OF THE DRAWINGS

Embodiments are illustrated by way of example, and not limitation, in the figures of the accompanying drawings, in which like references indicate similar elements and in which:

FIG. 1 shows a block diagram illustrating a system environment suitable for implementing methods of wellness monitoring.

FIG. 2 shows a block diagram illustrating a system environment suitable for implementing methods of lifestyle managing.

FIG. 3 shows a block diagram of the lifestyle managing system.

FIG. 4 is a process flow diagram showing a method for wellness monitoring.

FIG. 5 is a diagrammatic representation of an example machine in the form of a computer system within which a set of instructions, for the machine to perform any one or more of the methodologies discussed herein, is executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made, without departing from the scope of what is claimed. The following detailed description is, therefore, not to be taken in a limiting sense, and the scope is defined by the appended claims and their equivalents.

The techniques of the embodiments disclosed herein may be implemented using a variety of technologies. For example, the methods described herein may be implemented in software executing on a computer system or in hardware utilizing either a combination of microprocessors, or other specially designed application-specific integrated circuits (ASICs), programmable logic devices, or various combinations thereof. In particular, the methods described herein may be implemented by a series of computer-executable instructions residing on a storage medium such as a disk drive or a computer-readable medium.

The embodiments described herein relate to computer-implemented methods for managing the lifestyle of individuals. These methods can be implemented utilizing a number of various devices/systems including, but not limited to, computers, servers (e.g., web-enabled servers), cellular phones, smart phones, PDAs, exercise machines, smart television systems, or any combination thereof. Without regard to what system is used, the present teachings involve acquiring various and multiple parameters related to the physical and mental condition of a given individual. These parameters may refer to psychophysical parameters (e.g., weight, height, heart rate, heart rate variability, blood pressure, blood sugar, cholesterol, stress level, activity level, rest level, calories burned, and sleep quality level), physical activity parameters (e.g., speed, distance, number of steps, acceleration, and cadence), foods-consumed parameters (e.g., consumed calories, type of foods, and foods-consumed amount), various physical and/or mental parameters, or any combination thereof. These parameters may be either measured via dedicated and ad hoc sensors or can be input via various input devices. In either case, the parameters are gained in real time or non-real time on a regular basis.

Once parameters are obtained, they are compared to predetermined reference values to calculate possible deviations. A wellness index can be calculated based on the deviations. The wellness index is a simple and single representation of an individual's lifestyle which may include health, wellness, and fitness conditions. In other words, the wellness index is a simple representation of all measured and/or input parameters. The wellness index can be readily visualized. For example, it can be given in terms of “acceptable” and “unacceptable,” or it can be represented by the values “low,” “medium,” and “high.” In either case, the wellness index is intuitively easy to understand, and there is no need for individuals to remember reference values or make any assessments regarding the deviations.

The wellness index is then monitored constantly over a period of time, and the individual is enabled to set goals such as improving his health, wellness, fitness conditions, or sport results by increasing his wellness index and/or other measured parameters. To help in this process, the present teachings also imply the generation of various suggestions or proposal actions which may enable an individual to effectively achieve his goals. The suggestions may refer to an exercise plan, nutrition plan, exercise program for an exercise machine, and so forth. In various embodiments, the suggestions are generated and delivered to the individual may also be based on one or more mediators. A mediator represents the mechanism through which the intervention is believed to influence physical activity or healthy eating behavior. Among adults, mediators, most responsive to modification and consistently associated with physical activity and healthy eating adoption include the following: Goal Setting; Self-Monitoring; Social Support; Self-Efficacy; Reward Setting; Expected Benefits; Perceived Barriers; Decisional Balance; Exercise Enjoyment.

The ideal mediator or mediators to be elicited need to be previously identified by prompting a user to answer a set of predetermined questions, a questionnaire, a survey, and so forth, which may relate to user's health condition. The mediators may also be determined based upon the wellness index and various factors, conditions, or parameters monitored. Based upon the provided answers and/or parameters/wellness index, one or more mediator can be determined. In various embodiments, one or more predetermined mediators may be selected based upon provided answers and/or parameters/wellness index. In further embodiments, the mediators can be determined or selected when one or more of various parameters (physiological, physical activity, and foods-consumed) and the wellness index reach (exceed) a predetermined limit. In an another example, corresponding mediators are determined and subsequently triggered when one or more objectives set by the individual are achieved (e.g., a goal to do physical training three times a week, or a goal to loose five pounds in weight during a week). In yet another example, corresponding mediators are determined and subsequently triggered when social networking feedbacks are received (e.g., when the individual receives favorite posts, messages, “likes,” etc., via a social networking site, blogging site, or other means of communication). Further, the mediators are determined and subsequently triggered when the individual gains a predetermined amount of virtual points, rewards, or incentives, when one or more obstacles defined by the individuals are overcome (e.g., an obstacle to run faster than a certain speed), and when a self-efficacy level, enjoyment level, or decision-making balance level reaches or exceeds a predetermined limit. It should be understood that the mediators may relate to a number of different conditions, which will be disclosed below in more detail.

Accordingly, when at least one mediator is determined and subsequently triggered, a corresponding message, note, suggestion, or proposal can be generated and delivered to the individual. In general, these messages or proposals are intended to suggest effective ways for the individual to achieve his or her goals and/or improve the wellness index and/or improve certain measured parameters. The messages or proposals can be adaptive and cognitive in the sense that they assess the current wellness condition of the individual, set goals, identify obstacles, and so forth. These messages may further encourage, reward, and inspire the individual. The proposals may be presented by way of a new or updated training program or nutrition plan. In additional embodiments, the proposals may include a training program given in a computer-readable form so that an exercise machine may implement it.

The measured parameters, wellness index, rewards, messages, and proposals may be accumulated and stored in the computer-readable medium. This information can be effectively and visually presented to the individual for further assessment of his or her progress over a period of time.

Therefore, the present disclosure provides a useful and effective means for managing the lifestyle of individuals, and also suggests the best ways to improve these conditions based upon a cognitive analysis of various psychophysical parameters, set goals, obstacles, and related information. The following provides the detailed description of various embodiments related to methods and systems for wellness monitoring.

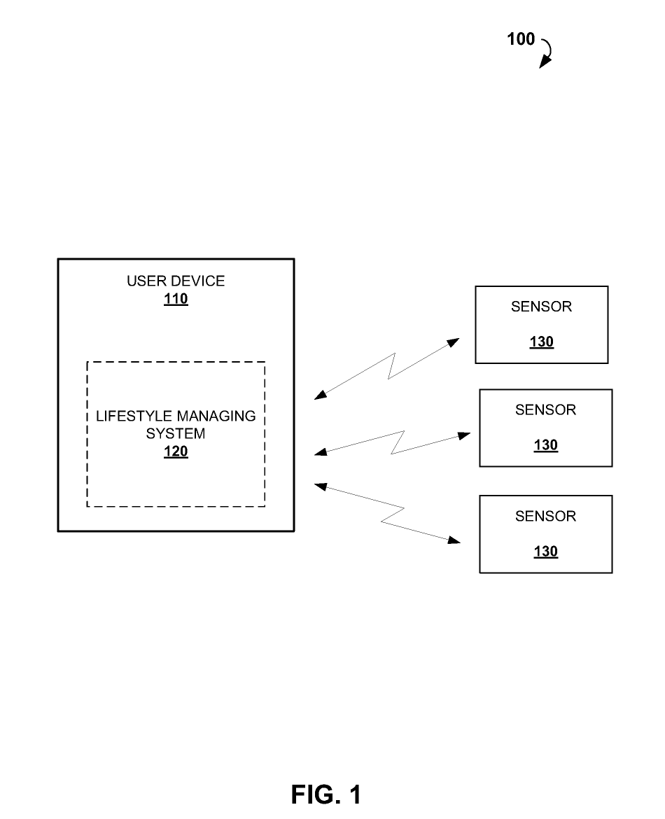

Referring now to the drawings, FIG. 1 shows a block diagram illustrating a system environment 100 suitable for implementing methods managing the lifestyle of individuals. In particular, the system environment 100 comprises a user device 110, a lifestyle managing system 120, and a plurality of sensors 130.

The user device 110 refers to an electronic computing device having the ability to process data. Examples of the user device 110 include a computer, server, laptop computer, desktop computer, tablet computer, portable computing device, thin client, PDA, handheld cellular phone, mobile phone, smart phone, smart television system, set-top box, and so forth. In various embodiments, the user device 110 may also refer to an exercise machine such as a treadmill, elliptical machine, glider machine, climbing machine, rowing machine, exercise bicycle, or weight machine. Any of these exercise machines may have an embedded computing unit and network functionality.

The lifestyle managing system 120 is configured to implement methods for managing the lifestyle of individuals as described herein. The lifestyle managing system 120 may be implemented as computer codes, software, firmware, hardware, or any combination thereof. In the shown embodiment, the lifestyle managing system 120 is incorporated into the user device 110. In an example, if the user device 110 is a smart phone or tablet computer, the lifestyle managing system 120 may be implemented as a mobile application. In another example, if the user device 110 is an exercise machine, the lifestyle managing system 120 may be implemented as hardware components and processor-implementable codes, both incorporated into the user device 110. It should be understood that various embodiments are possible depending on the application.

With continuing reference to FIG. 1, the sensors 130 refer to any device configured to measure biometric, physical or psychophysical parameters. The sensors 130 can be operatively coupled to the user device 110, and, more specifically, to the lifestyle managing system 120. The coupling between the sensors 130 and the user device 110 can be via wire or wireless, and it may use any suitable data transfer protocols (e.g., ANT or ANT+ protocol). According to further embodiments, the sensors 130 may be integrated with the user device 110 or the lifestyle managing system 120.

In an example, the sensors 130 may be configured to one or more physiological parameters including weight, height, heart rate, heart rate variability level, blood pressure, blood sugar, blood characteristics, cholesterol, exhaled breath characteristics, stress level, activity level, rest level, calories burned, and so forth. Examples of such sensors 130 include heart rate monitors, blood pressure sensors, sleep/activity tracking systems, and so forth.

According to another example, the sensors 130 may be also configured to measure one or more physical activity parameters. The physical activity parameters may comprise one or more of speed (when a user is running or cycling), distance, number of steps, acceleration, and cadence. Examples of such sensors 130 include pedometers, accelerometers, running/cycling tracking systems, exercise taken tracking computer-enabled systems, Global Positioning System (GPS) tracking systems, and so forth.

Additionally or alternatively, the sensors 130 may be further configured to measure one or more foods-consumed parameters. The foods-consumed parameters may comprise one or more of consumed calories, types of food, foods-consumed amount, and so forth. In this case, the sensors 130 may be integrated with the user device 110 so that the user device 110 may enable the user to scan a bar code related to a certain nutrition product or take a photo of a certain nutrition product such that the user device 110 may determine the type of product and calculate a number of calories to be consumed.

It should be understood that the sensors 130 can measure the parameters in real time and the parameters measured can be provided to the user device 110 constantly or over certain periods of times (e.g., during a training). In other embodiments, the parameters measured can be input to the user device 110 in non-real time (e.g., manually after a training).

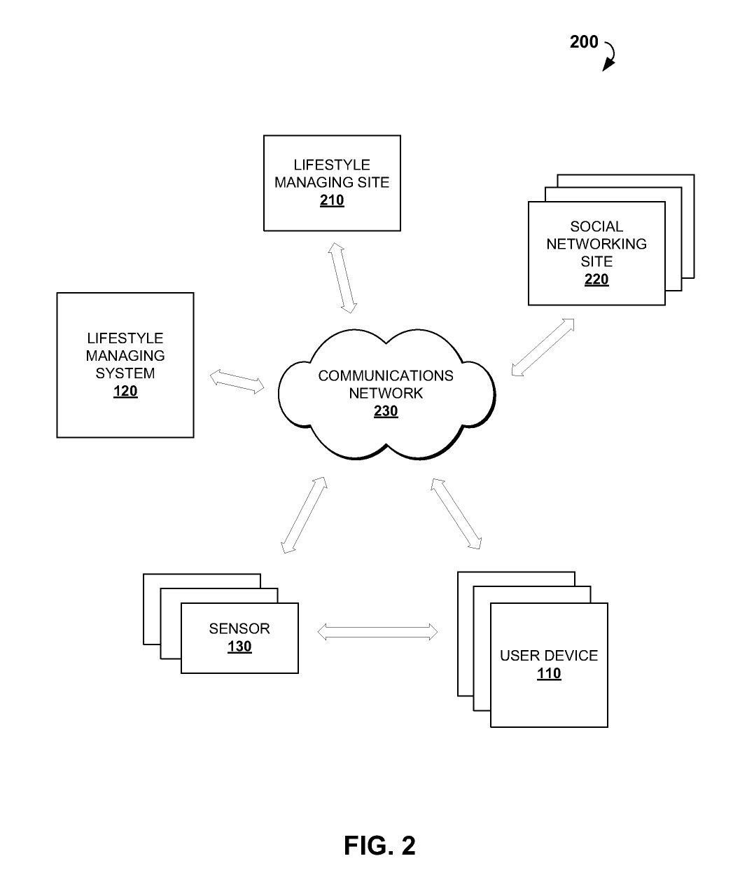

FIG. 2 shows a block diagram illustrating a system environment 200 suitable for implementing methods for managing lifestyle of individuals, according to another exemplary embodiment. In the example shown, the system environment 200 comprises a plurality of user devices 110, the lifestyle managing system 120, a plurality of sensors 130, a lifestyle managing site 210, one or more social networking sites 220, and a communications network 230, which may operatively couple all mentioned modules.

The major difference of this embodiment is that the lifestyle managing system 120 is configured as a stand-alone system (e.g., a server), which can be accessed via the communications network 230. In particular, the user devices 110 may have a browser or dedicated software application to communicate with the lifestyle managing system 120. As was mentioned, although the method steps for wellness monitoring are implemented by the lifestyle managing system 120, it should be understood that only some method steps can be performed by the lifestyle managing system 120, while other method steps can be performed by the user devices 110 separately or in combination with activity performed by the lifestyle managing system 120. In other words, the lifestyle managing system 120 can either be integrated into the user device 110, be a stand-alone system, or both. In any case, the lifestyle managing system 120 is configured to implement, or facilitate implementation of, the methods for wellness monitoring as described herein.

With continuing reference to FIG. 2, the user device 110 may refer to any electronic computing device having at least a network interface allowing communication with the lifestyle managing system 120, an input device, and/or a display. Some examples of the user device 110 include a computer, tablet computer, thin client, smart phone, exercise machine, and so forth.

The sensors 130 are configured to measure physiological parameters (e.g., weight, height, heart rate, heart rate variability level, blood pressure, blood characteristics, exhaled breath characteristics, activity level, rest level, etc.), physical activity parameters (e.g., a speed, distance, number of steps, acceleration, and cadence), and foods-consumed parameters (e.g., consumed calories, type of foods, and foods-consumed amount). The sensors 130 are further configured to transmit digitized parameter values or other parameter characteristics to the lifestyle managing system 120 (directly or via the user device 110) and/or the user device 110. To this end, the sensors 130 may have a network interface to enable them to send the parameter values directly or over the communications network 230. It should also be understood that the sensors 130 refer to hardware and/or software components. In example embodiments, the sensors 130 can be integrated with the user device 110.

With continuing reference to FIG. 2, the system environment 200 may also have the lifestyle managing site 210 which can be hosted by a stand-alone server or the lifestyle managing system 120. The lifestyle managing site 210 may facilitate how users track their activities, parameters measured by the sensors 130, and, in particular, the wellness index. In an example embodiment, the lifestyle managing site 210 may enable the users to establish personal profiles so that the users may review their progress, and, in particular, the parameters measured, wellness index, suggestions, rewards, and so forth, at a glance. The lifestyle managing site 210 may also enable the users to make inputs such as their goals, obstacles, objectives, and also some or all of biometric, psychophysical, or foods-consumed parameters. The users may indicate, for instance, the parameters measured by sensors or other devices which cannot be coupled to the user device 110 or the lifestyle managing system 120 for one or more reasons. In an example, the user may input his or her height, weight, blood characteristics, and so forth.

Furthermore, the lifestyle managing site 210 may facilitate the calculation of some parameters (e.g., foods-consumed parameters). The user may simply upload pictures of the food to be consumed or photos of its packaging photos, or input the bar code number, and the lifestyle managing site 210 may help determine nutrition values for the food products and calculate consumed calories. In another example, the user may merely input nutrition values as given on packages of the food product to be consumed. In either case, the lifestyle managing site 210 may facilitate a way of determining or inputting parameters to the lifestyle managing system 120 for further processing. It should be also understood that the lifestyle managing site 210 may be used in addition to the software application installed in the user device 110 so that the users may review their wellness index and progress in improving their health not only via their own user device 110 having dedicated software, but also via any computer with a browser connected to the Internet.

In additional embodiments, the lifestyle managing site 210 may provide communication functionality so that the users may communicate with other users, coaches, friends, family members, and so forth. In one example, the lifestyle managing site 210 may be embedded or operatively coupled to one or more social networking sites 220. The users may even log into their profiles in the lifestyle managing site 210 via a social networking site 220.

The term “social networking site” is used herein to refer to various online and software tools that enable people to communicate via the communications network 230 (e.g., the Internet) and share information and resources (text, audio, video, images, podcasts, and other multimedia). The social networking sites 230 may further include blogs, micro-blogs, podcasts, chats, web feeds, content-sharing tools, and so forth.

Any activity, inputs, progress, messages, posts, images, rewards, and other media content originating from the lifestyle managing site 210 and/or the lifestyle managing system 120 and/or the user device 110 can be shared via the social networking sites 220. In addition, the lifestyle managing site 210 may also receive messages, posts, “likes,” and other media content from the social networking sites 220. Accordingly, social feedback can be effectively provided to the users.

With continuing reference to FIG. 2, the communications network 230 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port, such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS, CDPD (cellular digital packet data), RIM (Research in Motion, Limited) duplex paging network, Bluetooth radio, or an IEEE 802.11-based radio frequency network. The communications network 230 can further include or interface with any one or more of the following: RS-232 serial connection, IEEE-1394 (Firewire) connection, Fiber Channel connection, IrDA (infrared) port, SCSI (Small Computer Systems Interface) connection, USB (Universal Serial Bus) connection, or other wired or wireless, digital or analog interface or connection, mesh or Digi® networking.

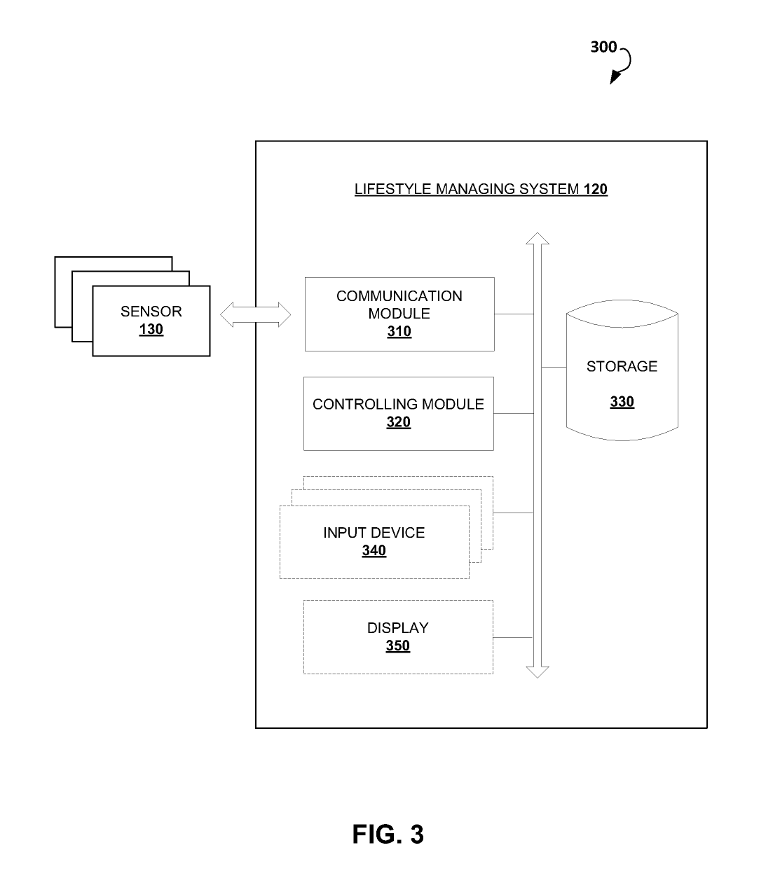

FIG. 3 shows a block diagram of the lifestyle managing system 120. In this embodiment, the lifestyle managing system 120 may include, embed, or be coupled to a communication module 310, a controlling module 320, and storage 330. The lifestyle managing system 120 may optionally include one or more input devices 340 and a display 350. The lifestyle managing system 120 may be coupled to one or more sensors 130 directly or via a communications network 230. According to an alternative embodiment, one or more sensors 130 may be incorporated into the lifestyle managing system 120. It should be mentioned that all of these modules can be integrated within a single apparatus, or, alternatively, can be remotely located and optionally accessed via a third party. The lifestyle managing system 120 may further include additional modules, but the disclosure of such modules is omitted so as not to burden the entire description of the present teachings.

The communication module 310 can be configured to acquire one or more of the physiological, physical activity, and foods-consumed parameters. These parameters can be either measured by the sensors 130 and transmitted to the communication module 310 or can be input via one or more of the input devices 340. In further embodiments, the communication module 310 can be configured to acquire at least one image or bar code of a nutrition product to be consumed by a user. Other functions of the communication module 310 may include the reception and transmission of data to/from the user device 110, the lifestyle managing site 210, and/or the social networking sites 220.

With continuing reference to FIG. 3, the controlling module 320 can be configured to calculate a wellness index based upon one or more of the physiological parameters, physical activity parameters, and foods-consumed parameters. The wellness index can be calculated repeatedly (for example, every time new parameters are obtained), once in a day, or the like. The wellness index can have a numeric value or can be represented by terms such as “acceptable” or “unacceptable.” In other examples, the wellness index related to a certain user may be represented by the values of “low,” “medium,” and “high.” Those skilled in the art would appreciate that various examples of wellness index representation can be used.

In general, the wellness index can be merely a “summary” of all acquired parameters (physiological parameters, physical activity parameters, and foods-consumed parameters) measured during a certain time period. However, in further embodiments, calculation of the wellness index is a difficult task, as it may consider not only the parameters measured, but also sought goals, obstacles, objectives set by the user, illnesses, current physical and mental condition, health or fitness condition, and so forth. For example, running a 1 km distance can be an easy task for a healthy user, but when the user suffers from obesity, it can be difficult to run this distance, and it should be understood that the parameters measured for both cases will be treated differently; thus, the wellness index is calculated differently. Accordingly, the controlling module 320 can cognitively calculate the wellness indicia based on evidence.

Furthermore, the controlling module 320 can also be configured to generate proposal actions to the user so as to improve the wellness index. The proposal actions can be generated based on predetermined (and tunable) criteria and settings, and take into account the parameters measured over a period of time, progress in improvement of the wellness index, suggestions, and so forth. In general, to facilitate the generation of the proposal actions, the controlling module 320 can determine one or more “mediators”. The mediators will be described below in more detail.

The storage 330 is configured to store user profiles, parameters measured, calculated wellness index, messages, settings, goals, obstacles, and so forth. Accordingly, in operation, each time new parameters are measured or acquired by the lifestyle managing system 120, they can be stored in the storage 330. Similarly, any activity in the user profiles, suggestions, change in wellness indicia, and the like can be monitored and stored or updated in the storage 330.

In various embodiments, the storage 330 may include a database having the measured parameters and also reference limits to which the measured parameters are compared. Each combination can be associated with a specific reference profile (having certain predetermined characteristics) corresponding to a reference wellness index, which is calculated on the basis of a relative combination of reference parameters. This database may also include preset data previously generated on the basis of medical and scientific information. In operation, once new parameters are obtained, they can be compared to the reference limits related to a corresponding profile so as to calculate a wellness index that represents a specific psychophysical condition of the user.

For example, the database can include a list of reference profiles, classified according to the following characteristics:
A) “Sedentary—Overweight—Stressed”
B) “Active—Slim—Stressed”
C) “Active—Slim—Not stressed”

For each reference profile there will be a corresponding set of preset reference parameters (e.g., Pa′, Pb′, Pc′) associated with a specific reference wellness index, based on experimental, medical, and scientific data.

With continuing reference to FIG. 3, the input device 340 may be configured to enable the users to input information (e.g., answers to various questions, parameters measured by non-linked sensors, etc.), which can then be transmitted to the communication module 310. The input device 340 may include, but is not limited to, a keyboard, keypad, touchpad, touchscreen, mouse, gamepad, joystick, microphone, exercise machine input device, and so forth. The input made by the users via the input device 340 may refer to one or more parameters, nutrition information, settings, messages, description/selection of obstacles, objectives, goals, and so forth.

With continuing reference to FIG. 3, the display 350 may be any suitable displaying device such as a flat panel, Liquid Crystal Display (LCD), Organic Light Emitting Diodes (OLED) display, a television receiver, and so forth. In general, the display 350 may be used to display parameters measured, the wellness index, progress in improvement of health, wellness, or fitness conditions, messages, websites, and so forth.

In operation, the controlling module 320 receives the parameters originally measured by the sensors 130 or input via the input device 340, and communicates with the storage 330 in order to compare the combination of parameters measured (e.g., Pa, Pb, Pc) with preset reference parameters (e.g., Pa′, Pb′, Pc′). When a matching combination is found, the controlling module 320 may determine a reference wellness index and an associated reference user profile. Further, the user's wellness index is calculated so that it corresponds, for example, to the value associated with the reference wellness index and the associated reference user profile.

Alternatively, when the controlling module 320 cannot find a matching combination, deviations between the parameters measured (e.g., Pa, Pb, Pc) and preset reference parameters (e.g., Pa′, Pb′, Pc′) can be determined. Thus, the controlling module 320 may find two or more reference wellness indices and hence, multiple reference profiles. In this case, the user's wellness index, corresponding to the parameters measured, can be calculated as a statistical median value of the multiple wellness indices (i.e., an average numerical value).

Further, once the above information has been processed, the results (e.g., wellness index) can be shown to the user on the display 350 or sent to one or more user devices 110.

It should be also mentioned that the user may set or tune various settings to the user profile. Examples of settings may include age, gender, height, weight, and so forth. The more details that are defined by the user, the more accurate the calculation of the wellness index can be.

The wellness index can be represented as a numerical value (for example, from 0 to 100); however, in various embodiments, the wellness index can be evaluated so as the user may easily interpret it. As mentioned, the wellness index may be evaluated and presented in terms of “Acceptable—Unacceptable,” “Low—Medium—High,” or the like. Accordingly, the controlling unit 320 may not only calculate the wellness index, but also evaluate it in the given terms. To this end, the parameters measured may be stored repeatedly during a series of preset intervals. The evaluation of the wellness index can be performed during these intervals so that a change of wellness index over a certain time period can be illustrated using graphics. For example, a circular graph can be used, in which the intervals of preset values are associated with different colored sections, and the user's wellness index is represented with a pointer that can turn and position itself in one of the areas shown. The red color can be associated with an area of “low” or “unacceptable” wellness index reference values, while the green color can be associated with an area of “high” or “acceptable” wellness index reference values. This form of representation can be intuitive for the user, who can constantly monitor his/her wellness index and receive instant feedback on any changes over time.

The wellness index is a dynamic parameter that may vary over time according to changes in the user's activity and state of physical and mental well-being. Thus, in other embodiments, the wellness index may be illustrated as a plot of wellness index calculated against time.

As mentioned, the lifestyle managing system 120 may provide proposal actions to the user so as to improve, in general, the lifestyle, and, in particular, the wellness index. The proposal actions may refer to suggestions, training programs, exercise programs, nutrition plans, physical activity plans, target objectives, a target wellness index, a target physiological parameter, a target physical activity parameter, a target foods-consumed parameter, and so forth. In various embodiments, the proposal actions can be represented as text, video, audio, media content, computer-implementable codes, and so forth. The proposal actions can be delivered via the user device 110 such as a computer, smart phone, exercise machine, and so forth.

More specifically, the lifestyle managing system 120 generates proposal actions based on the wellness index and/or based on one or more mediators. In general, mediators represent a mechanism through which the intervention is believed to influence physical activities or healthy eating habits. For adults, mediators which are responsive to modification and consistently associated with physical activities and healthy eating habits include the following: Goal Setting; Self-Monitoring; Social Support; Self-Efficacy; Reward Setting; Expected Benefits; Perceived Barriers; Decisional Balance; Exercise Enjoyment. According to various embodiments, mediators can be determined by prompting a user to answer a set of predetermined questions using a questionnaire, a survey, and so forth, which may relate to user's health condition. The mediators may also be determined based upon the wellness index and various factors, conditions, or parameters monitored. Once at least one mediator is determined for the user, the lifestyle managing system 120 generates proposal actions according to predetermined settings associated with the determined mediator(s). In broad terms, the mediators may relate to specific conditions associated with one or more of the physiological parameters, physical activity parameters, foods-consumed parameters, wellness index, user objective, social networking feedback, user obstacles, self-efficacy level, enjoyment level, and decision-making balance. When one or more of these parameters reach (exceed) predetermined levels or meet a specific predetermined condition, the mediator is determined, which further leads to generation (retrieving from the storage 330) of a dedicated proposal action.

In greater detail, the lifestyle managing system 120 can suggest and propose to the user at least one action or activity in order to effectively stimulate the user to make changes in health or wellness. By “change,” it is meant the process that leads to the adoption of a healthier lifestyle, marked by an excellent wellness index, for a given user. Techniques related to generation of proposed actions (as implemented, for example, by the controlling module 320) are based on psychological theories developed to explain and condition the process of change. These psychological theories are based on one or more mediators, which, if suitably stimulated, can contribute to engendering a process of change. The main mediators, which can be advantageously used by the lifestyle managing system 120, are listed below:

### Goal Setting

The user can be prompted by the lifestyle managing system 120 to set one or more objectives or goals to be achieved (e.g., “I want to lose twenty pounds,” “I want to keep my diabetes under control,” and so on). These objectives can be stored in the storage 330 and constantly monitored.

Experts have found that setting goals and objectives is essential to ultimately achieving a desired outcome. In fact, goal-setting can be a key to success in achieving anything. The clearer the goal, the more likely it is that a given user will achieve his or her behavior change. Effective goals should be specific, realistic, and measurable; short-term and long-term; and provide feedback.

### Self-Monitoring

Self-monitoring is a strategy used to measure and track success. It allows the users to see their progress over time. By measuring their progress, they are able to observe patterns of behaviors, ups and downs, and make appropriate adjustments in order to better achieve their goals. Self-monitoring can also serve to prompt the users to engage in physical activity. Maintaining compliance with self-monitoring can be difficult. Thus, it may be best to use comprehensive self-monitoring strategies and tools early on and more abbreviated, quicker systems over the long-term. Thus, the lifestyle managing system 120 may serve as a tracking tool to self-monitor physical activity and behavior change. In particular, the lifestyle managing system 120 may enable the users to track their physiological parameters, physical activity parameters, foods-consumed parameters, and wellness index.

### Social Support

Social support can be defined as a “support system” that motivates the users to adopt and maintain a new behavior. It can come from many different sources including family, friends, co-workers, health/fitness professionals, personal trainers, fitness instructors (real or virtual), and/or other exercisers. As mentioned, the lifestyle managing system 120 may enable the users to communicate with each other and share information with friends and interested people via the lifestyle managing site 210, the social networking sites 220, or dedicated software installed in the user devices 110.

### Self-Efficacy

Self-efficacy may refer to one's confidence in their ability to perform specific behaviors in specific situations. In other words, it is a belief that one can successfully perform the desired behavior. Self-efficacy can be also based in part on past adult exercise experience. Both good and bad experiences influence self-efficacy, as do the examples provided by others (i.e., modeling of the desired behavior). Perceived self-efficacy can determine whether or not a user even attempts a given task; the degree of persistence when the user encounters difficulties; and the user's ultimate success or failure outcome. In addition, self-efficacy is behavior-specific, (i.e., one may feel confident walking, and cycling, but not performing strength training exercises).

The lifestyle managing system 120 may facilitate the user's adoption of the specified behavior (e.g., managing to jog for 20 minutes, starting to eat properly).

### Expected Benefits or Rewards

Many of the widely accepted behavioral change theories inform us that acquiring a new behavior typically requires frequent rewards and positive consequences to reinforce the newly adopted behavior. Rewards can be tangible or extrinsic. Extrinsic rewards can be effective in the short-term and provide immediate incentive for new exercisers to keep exercising. Rewards can also be intrinsic, such as feelings of accomplishment and increased vigor. It is important to note that it often takes time before intrinsic rewards are realized. The lifestyle managing system 120 may enable the provision of rewards, like virtual points or laudable media messages, to the users. The rewards can be provided once one or more specific mediators are determined.

### Perceived Obstacles

Adults who wish to change their physical activity and dietary habits often are unaware that there are internal and external cues that trigger their health habits and choices. Internal cues include thoughts and feelings. For example, feeling depressed may prompt someone to eat excessive amounts of a favorite food or to skip a planned workout. External cues include just about anything in a person's environment from other people, to the neighborhood in which he lives, to weather conditions. The key to using the construct of stimulus control in health behavior change is to help adults find ways to manipulate internal and external stimuli in ways that either reduce or replace unsupportive triggers and add supportive triggers for new, healthier habits. While stimulus control has not been shown to be a strong independent mediator for physical activity and healthy eating behavior change, it is often included as a strategy in cognitive-behavioral interventions, especially as a problem-solving related strategy. Accordingly, the lifestyle managing system 120 may enable the users to track perception of existing obstacles.

Thus, as illustrated above, the lifestyle managing system 120 is configured to generate at least one proposal action to be recommended and proposed to the user, based on the psychological theory of mediators. By acting on these mediators, the user can be effectively stimulated to follow the suggestions given, and perform the activities recommended by the lifestyle managing system 120 so as to improve his or her wellness index and psychophysical condition.

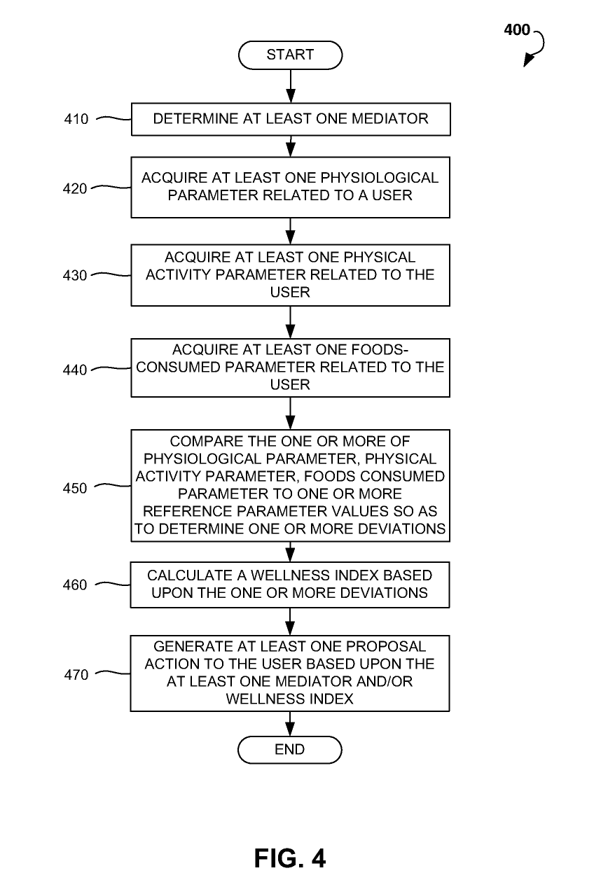

FIG. 4 is a process flow diagram showing a method 400 for managing the lifestyle of individual. The method 400 may be performed by processing logic that may comprise hardware (e.g., dedicated logic, programmable logic, and microcode), software (such as software run on a general-purpose computer system or a dedicated machine), or a combination of both. In one example embodiment, the processing logic resides at the lifestyle managing system 120. Each of these modules can comprise processing logic. It will be appreciated by one of ordinary skill that examples of the foregoing modules may be virtual, and instructions said to be executed by a module may, in fact, be retrieved and executed by a processor. The foregoing modules may also include memory cards, servers, and/or computer discs. Although various modules may be configured to perform one or more steps described herein, fewer or more modules may be provided and still fall within the scope of various embodiments.

As shown in FIG. 4, the method 400 may commence at operation 410 with the controlling unit 320 determining one or more mediators. As mentioned above, the mediators are specific conditions related to individual's lifestyle, exercise and eating habits, and so forth. One or more mediators can be determined by prompting the user to answer a set of predetermined questions, such as a questionnaire, a survey, and so forth, which may be indicative of user's health condition. The mediators may also be determined based upon the wellness index and various factors, conditions, or parameters monitored. In further embodiments, the mediators can be determined or selected when one or more parameters (e.g., physiological, physical, and nutritional) and the wellness index reach (or exceed) a predetermined limit. In another example, corresponding mediators can be determined when one or more objectives set by the user are achieved (e.g., a goal to engage in physical exercise three times a week, or a goal to loose five pounds in two weeks). It should be understood that any combinations of mediators can be used.

At operation 420, the communication module 310 acquires at least one physiological parameter related to a user. The physiological parameters can be measured by the sensors 130 (e.g., heart rate monitors, blood pressure sensors, sleep/activity tracking systems, and so forth) or be input by the user via the user device 110.

Similarly, at operation 430, the communication module 310 acquires at least one physical activity parameter related to the user. The physical activity parameters may be comprised of one or more of the following: speed (when a user is running or cycling), distance, number of steps, acceleration, and cadence. The physical activity parameters can be received from the sensors 130 (e.g., pedometers, accelerometers, running/cycling tracking systems, exercise taken tracking computer-enabled systems, GPS tracking systems, and so forth) or be input by the user via the user device 110.

At operation 440, the communication module 310 acquires at least one foods-consumed parameter related to the user. The foods-consumed parameters may refer to consumed calories, type of foods, and the foods-consumed amount. The foods-consumed parameters may be input by the user via the user device 110 or be calculated by the lifestyle managing system 120 based upon images of nutrition products or bar codes uploaded by the user.

At operation 450, the controlling unit 320 compares one or more of the physiological parameters, physical activity parameters, and foods-consumed parameters to one or more reference parameter values (stored in the storage 330) so as to determine one or more deviations between them (or an exact match).

At operation 460, the controlling unit 320 calculates a wellness index based upon the one or more deviations determined. More particularly, when parameters acquired are compared to reference parameters (at operation 440), there can be determined two or more reference wellness indicia associated with various reference parameters being the closest to the parameters acquired. These two or more reference wellness indicia can be then analyzed and a median value calculated, which will be considered as the wellness index of the user.

At operation 470, the controlling unit 320 generates at least one proposal action to the user so as to improve the wellness index and, thus, the user lifestyle based upon the determination of the at least one mediator. As mentioned, the proposal actions may refer to a target objective, target wellness index, target physiological parameter, target physical activity parameter, or target foods-consumed parameter. The proposal actions may also refer to a training program, exercise program, nutrition plan, physical activity plan, and so forth. The proposal actions can be delivered to the user via the display 350 and/or other means (e.g., speakers).

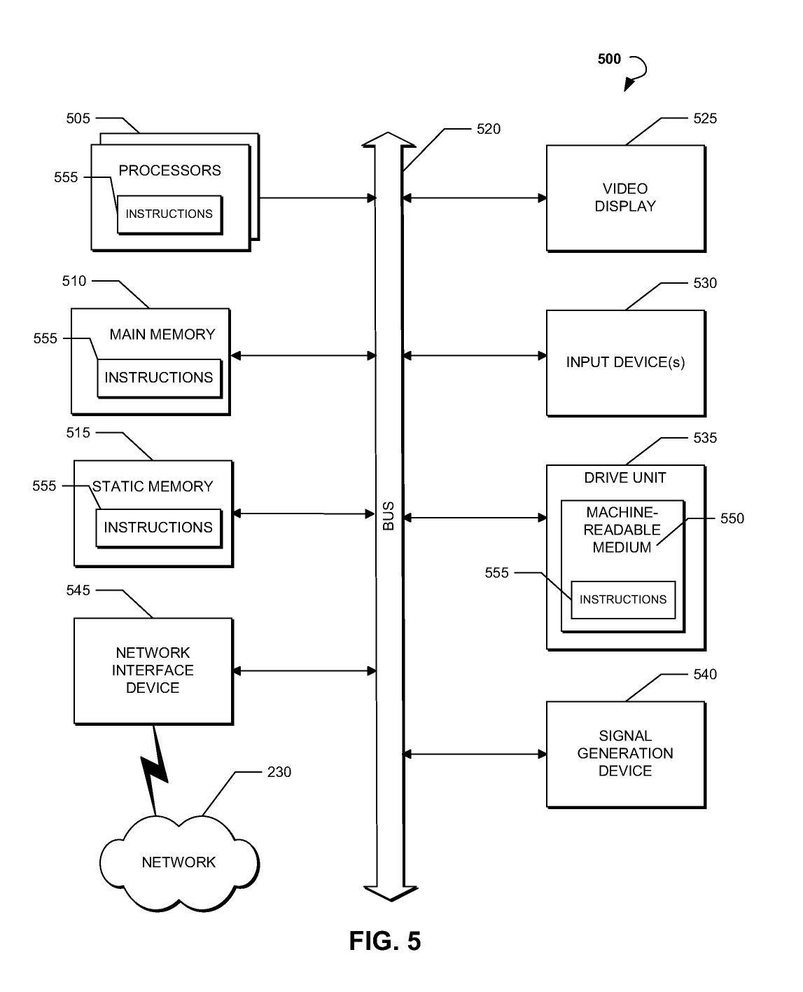

FIG. 5 shows a diagrammatic representation of a computing device for a machine in the example electronic form of a computer system 500, within which a set of instructions for causing the machine to perform any one or more of the methodologies discussed herein can be executed. In various example embodiments, the machine operates as a standalone device or can be connected (e.g., networked) to other machines. In a networked deployment, the machine can operate in the capacity of a server, or a client machine in a server-client network environment, or as a peer machine in a peer-to-peer (or distributed) network environment. The machine can be a personal computer (PC), a tablet PC, a set-top box (STB), a PDA, a cellular telephone, a portable music player (e.g., a portable hard drive audio device, such as a Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor or multiple processors 505 (e.g., a central processing unit (CPU), a graphics processing unit (GPU), or both), and a main memory 510 and a static memory 515, which communicate with each other via a bus 520. The computer system 500 can further include a video display unit 525 (e.g., a LCD or a cathode ray tube (CRT)). The computer system 500 also includes at least one input device 530, such as an alphanumeric input device (e.g., a keyboard), a cursor control device (e.g., a mouse), a microphone, a digital camera, a video camera, and so forth. The computer system 500 also includes a disk drive unit 535, a signal generation device 540 (e.g., a speaker), and a network interface device 545.

The disk drive unit 535 includes a computer-readable medium 550, which stores one or more sets of instructions and data structures (e.g., instructions 555) embodying or utilized by any one or more of the methodologies or functions described herein. The instructions 555 can also reside, completely or at least partially, within the main memory 510 and/or within the processors 505 during execution thereof by the computer system 500. The main memory 510 and the processors 505 also constitute machine-readable media.

The instructions 555 can further be transmitted or received over the network 230 via the network interface device 545 utilizing any one of a number of well-known transfer protocols (e.g., Hyper Text Transfer Protocol (HTTP), CAN, Serial, and Modbus).

While the computer-readable medium 550 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, flash memory cards, digital video disks, random access memory (RAM), read only memory (ROM), and the like.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, C#, .NET, Perl, UNIX Shell, Visual Basic or Visual Basic Script, Virtual Reality Markup Language (VRML), ColdFusion™ or other compilers, assemblers, interpreters, or other computer languages or platforms.

Thus, computer-implemented methods and systems for managing the lifestyle of individuals are disclosed. These methods provide a useful and effective way for improving health, wellness, and fitness conditions in an easy, intuitive, and interactive way. This evidence-based and cognitive technology may further help individuals adopt and maintain higher levels of physical activity and improved dietary habits during long period of times.

Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A computer-implemented method for managing lifestyle of a user, the method comprising:
acquiring at least one physiological parameter related to the user;
calculating a wellness index based upon the at least one physiological parameter; and
generating at least one proposed action, wherein the at least one proposed action is to improve the wellness index.

2. The method of claim 1, wherein the at least one physiological parameter comprises at least one of a weight, a height, a BMI (Body Mass Index), a waist circumference value, a heart rate, a heart rate variability level, a blood pressure, a blood sugar level, a cholesterol level, a stress level, an activity level, a rest level, a sleep quality level, and calories burned.

3. The method of claim 1, further comprising acquiring at least one physical activity parameter related to the user, wherein the wellness index being calculated is based further upon the at least one physical activity parameter.

4. The method of claim 3, wherein the at least one physical activity parameter comprises at least one of a speed, a distance, number of steps, an acceleration, a cadence, and a value calculated from data provided by an acceleration sensor.

5. The method of claim 1, further comprising acquiring at least one foods-consumed parameter related to the user, wherein the wellness index is calculated based further upon the at least one foods-consumed parameter.

6. The method of claim 5, wherein the at least one foods-consumed parameter comprises at least one of consumed calories, a type of foods, and a foods-consumed amount.

7. The method of claim 6, further comprising:
acquiring at least one image of a nutrition product to be consumed by the user;
determining nutrition values associated with the nutrition product; and
calculating the at least one foods-consumed parameter based upon the nutrition values.

8. The method of claim 1, wherein the at least one physiological parameter is acquired repeatedly over at least one period of time.

9. The method of claim 1, further comprising comparing the at least one physiological parameter to at least one reference parameter value so as to determine at least one deviation, wherein the wellness index is calculated based upon the at least one deviation.

10. The method of claim 1, further comprising:
determining at least one mediator; and
wherein generation of the at least one proposed action is based upon the at least one mediator.

11. The method of claim 10, wherein the at least one mediator is determined by processing user input associated with current physical or mental condition or by evaluating at least one of a physiological parameter, a physical activity parameter, a foods-consumed parameter, and the wellness index.

12. The method of claim 10, wherein generation of the at least one proposed action is further based upon achievement of at least one user objective.

13. The method of claim 10, wherein generation of the at least one proposed action is further based upon at least one social networking feedback.

14. The method of claim 10, wherein generation of the at least one proposed action is further based upon at least one reward.

15. The method of claim 10, wherein generation of the at least one proposed action is further based upon overcoming at least one obstacle defined by the user.

16. The method of claim 10, wherein generation of the at least one proposed action is further based upon at least one of a self-efficacy level, enjoyment level, and decision-making balance.

17. The method of claim 1, wherein the at least one proposed action comprises at least one of a training program, an exercise program, a nutrition plan, and a physical activity plan.

18. The method of claim 1, wherein the at least one proposed action comprises at least one of a target objective, target wellness index, target physiological parameter, target physical activity parameter, and target foods-consumed parameter.

19. A system for managing lifestyle of a user, the system comprising:
a communication module configured to acquire at least one physiological parameter related to the user; and
a controlling module configured to calculate a wellness index based upon the at least one physiological parameter, and to generate at least one proposed action, wherein the at least one proposed action is to improve the wellness index.

20. The system of claim 19, wherein the communication module is further configured to acquire at least one physical activity parameter related to the user, and wherein the wellness index is calculated further based upon the at least one physical activity parameter.

21. The system of claim 19, wherein the communication module is further configured to acquire at least one foods-consumed parameter related to the user, and wherein the wellness index is calculated based further upon the at least one foods-consumed parameter.

22. The system of claim 19, wherein the communication module is further configured to acquire at least one image of a nutrition product to be consumed by the user, and the controlling module is further configured to determine nutrition values associated with the nutrition product, and to calculate the at least one foods-consumed parameter based upon the nutrition values.

23. The system of claim 19, wherein the controlling module is further configured to compare the at least one physiological parameter to at least one reference parameter value so as to determine at least one deviation, wherein the wellness index is calculated based upon on the at least one deviation.

24. The system of claim 19, wherein the controlling module is further configured to determine at least one mediator; and wherein generation of the at least one proposed action is based upon the at least one mediator.

25. The system of claim 19, further comprising at least one sensor configured to measure one or more of physiological parameters and physical activity parameters.

26. The system of claim 19, further comprising a display.

27. The system of claim 19, further comprising at least one input device.

28. The system of claim 19, wherein the system comprises at least one of a computer, a cellular phone, a smartphone, a Personal Digital Assistant (PDA), and a physical exercise machine.

29. A non-transitory processor-readable medium having instructions stored thereon, which when executed by at least one processor, cause the at least one processor to:
acquire at least one physiological parameter related to a user;
calculate a wellness index based upon the at least one physiological parameter; and
generate at least one proposed action, wherein the at least one proposed action is to improve the wellness index.
